(19) United States
(12) Patent Application Publication
(10) Pub. No.: US 2013/0215242 A1
(43) Pub. Date: Aug. 22, 2013

(54) METHOD FOR DISPLAYING INFORMATION IN A STEREOSCOPIC OR BINOCULAR DISPLAY SYSTEM

(71) Applicants: Xavier SERVANTIE, Pessac (FR); Laurent LALUQUE, Bordeaux (FR); Bruno AYMERIC, St Medard en Jalles (FR)

(72) Inventors: Xavier SERVANTIE, Pessac (FR); Laurent LALUQUE, Bordeaux (FR); Bruno AYMERIC, St Medard en Jalles (FR)

(21) Appl. No.: 13/769,215

(22) Filed: Feb. 15, 2013

(30) Foreign Application Priority Data
Feb. 16, 2012 (FR) 1200443

(51) Int. Cl. H04N 13/04

(52) U.S. Cl. CPC H04N 13/0434
USPC 348/53

(57) ABSTRACT

The general field of the invention is that of the methods for displaying at least two non-stereoscopic images of a different nature intended to be superposed so as to form only one final image. The method according to the invention comprises the following two successive steps:
A first step for generation of the first image and of the second image, the two images being of a different nature and non-stereoscopic;
A second step for displaying the said images in a binocular or stereoscopic display system comprising two display channels, the first channel being intended for the right eye of a user, the second channel being intended for the left eye of the said user, the first image being displayed on the first right channel and the second image being displayed on the second left channel.

The field of the invention is that of systems for displaying different types of information that need to be presented as a superposition. There exist a large number of possible applications but the main field of application targeted is the field of aeronautics where the clear display of cartographic data is fundamental.

At the present time, there exist numerous display systems allowing superposed pieces of information integrated into the same format to be consulted. For example, in the field of cartography, numerous pieces of information of a very different nature can be superposed in one and the same image. Thus, aerial photographs, geographical coordinates, flight plans, etc. may be superposed. The readability of this superposition of information is sometimes difficult in view of the density of information presented.

It is of course possible to leave it to the user or to suitable software to only keep the important or useful information in such a manner as to improve the understanding of the image. The existing solutions for improving the readability operate via systems for specific parameter adjustments in order to allow the user to remove the information that is too dense. This requires actions by the user, and sometimes a sound knowledge of the operation of the system.

It is also possible to adjust the transparency or the semi-transparency of certain information in such a manner that the information is more contrasted.

The limits of the exercise will clearly be understood. The user must be sure that the information chosen is effectively the important information. in the field of aeronautics, this information is continually being updated depending on the phase of flight, weather conditions, etc.

Display systems currently exist that are used to generate stereoscopic or 3D effects.

Historically, for a certain number of applications relating notably to the helmet displays used in aeronautics, the equipment suppliers were led to develop binocular display systems, in other words display systems allowing two images to be displayed: the first image intended for the right eye of the user, the second for the left eye. Generally speaking, the images presented that are collimated at infinity are identical. However, in a binocular system, it is easy to generate stereoscopic images taking into account the difference in point of view due to the inter-pupil distance.

More recently, for cinematographic or television applications, display systems have been developed for displaying two stereoscopic images on one and the same screen thus allowing the illusion of relief to be created. These systems are based either on a spatial separation of the left and right images or on a separation by polarization.

In the first case, an array of micro-lenses disposed on the screen allows a first image dedicated to the right eye of the user to be projected at least in certain spatial directions and, in other spatial directions, a second image dedicated to the left eye of the user. It is possible to generate several different pairs of images so as to increase the visible area of the stereoscopic images. These are then referred to as auto-stereoscopic systems in the sense that the user does not need any additional optical accessory in order to obtain the three-dimensional effect.

In the second case, the screen displays a left image having a certain polarization and a right image having a different polarization. Means of optical selection disposed in front of the eyes of the user based on the difference in polarization of the light allow the image dedicated to each eye to be selected.

The object of the method according to the invention is to use the stereoscopic display systems previously described for displaying images on each eye comprising information of a different nature and no longer stereoscopic. Thus, the user receives two single images in monocular vision mode comprising a part of the information. In binocular vision mode, he receives the totality of the information, the superposition of the two monocular images being provided by the mechanisms for binocular vision of the user.

More precisely, the subject of the invention is a method for displaying at least two non-stereoscopic images of a different nature intended to be superposed so as to form only one final image, characterized in that the method comprises the following two successive steps:
A first step for generation of the first image and of the second image;
A second step for displaying the said images in a binocular or stereoscopic display system comprising two display channels, the first channel being intended for the right eve of a user, the second channel being intended for the left eye of the said user, the first image being displayed on the first right channel and the second image being displayed on the second left channel.

Advantageously, the binocular display system is a helmet display or the stereoscopic display system comprises a single display screen.

Advantageously, the first image or the second image comprises information of the planimetric or the cartographic type or comprises information relating to the piloting or the navigation of an aircraft.

The invention will be better understood and other advantages will become apparent upon reading the description that follows presented by way of non-limiting example and with the aid of the appended figures amongst which:

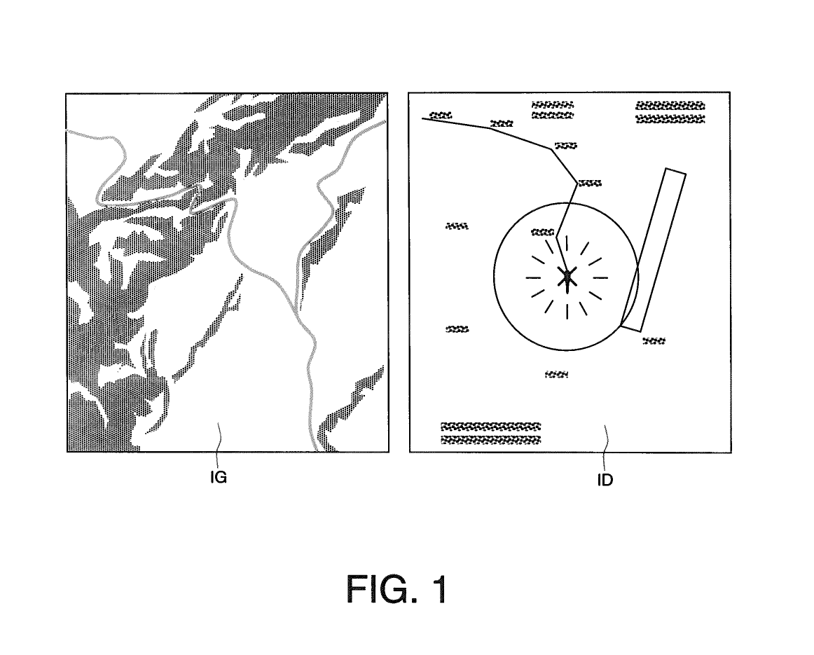

FIG. 1 shows the first step of the display method according to the invention;

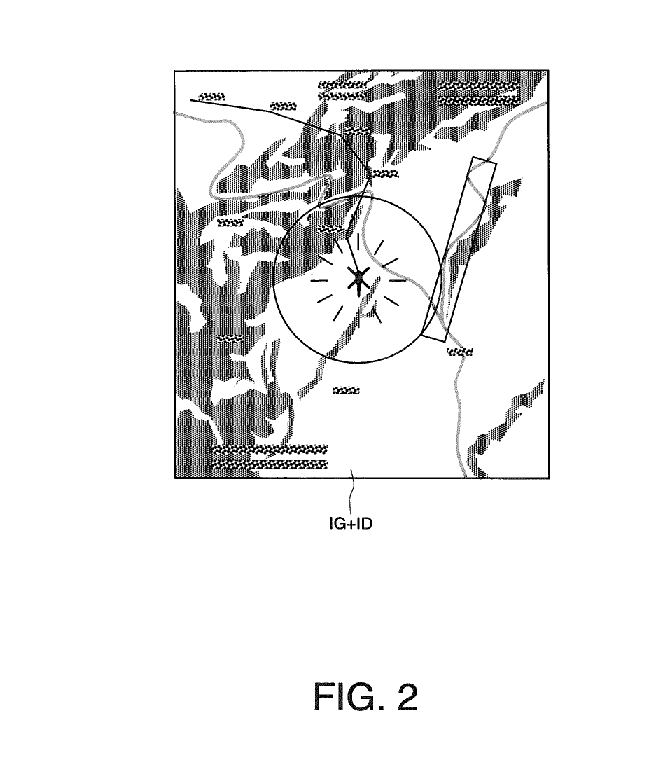

FIG. 2 shows the second step of the display method according to the invention;

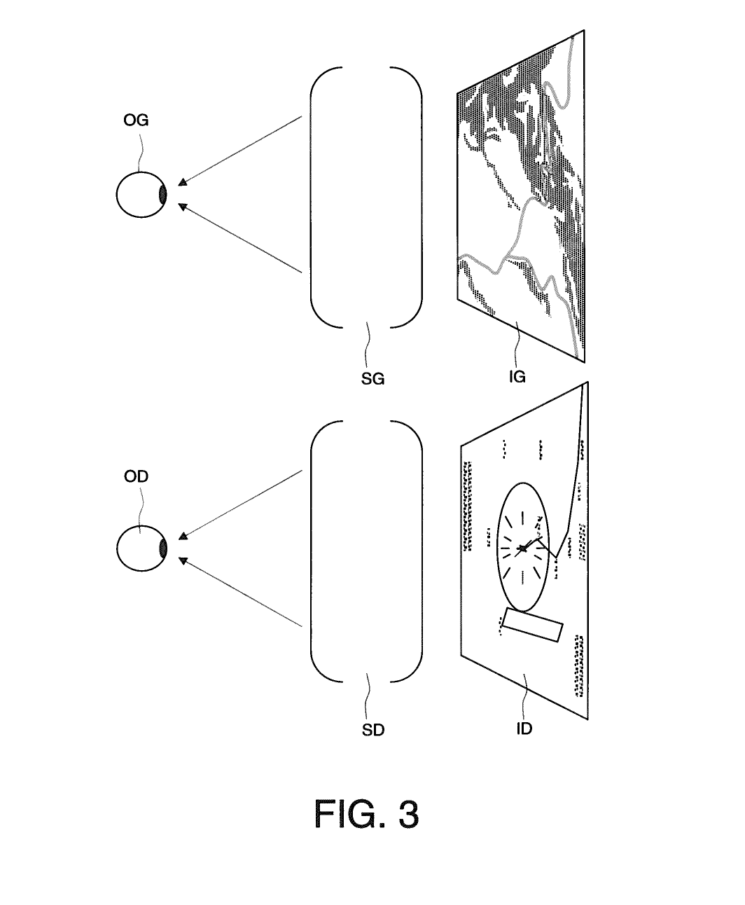

FIG. 3 shows the final result of the display method according to the invention.

The method according to the invention is based on the use of stereoscopic or binocular display systems for displaying images comprising information of a different nature on each eye.

The display method according to the invention comprises the two following successive steps illustrated in FIGS. 1, 2 and 3. The images in black and white shown in these figures are drawn according to the rules and the conventions of Patent figures. In reality, the images presented are usually in colour and accordingly much more informative.

A first step consists in generating the two images that it is desired to superpose. In the case of FIG. 1, these are images designed for the display of information in an aircraft cockpit.

The left image IG comprises information of the cartographic type. In the present case, this represents a top view of the terrain overflown. However, the view may also be a perspective view as seen by the pilot or any other view of the terrain.

The right image ID comprises navigation information relating to the route to be followed with a symbolic representation of the aircraft which, in the present case, is a helicopter. The position of these pieces of information corresponds to their precise location on the terrain shown in the left image IG. The information shown is of course presented purely by way of example.

The second step illustrated in FIGS. 2 and 3 consists in displaying the images ID and IG in a binocular or stereoscopic display system S comprising two display channels, the first channel being intended for the right eye OD of a user, the second channel being intended for the left eye OG of the said user, the first image ID being displayed on the first right channel and the second image IG being displayed on the second left channel.

By way of a first exemplary embodiment, the display system S used can be an autostereoscopic screen which displays several points of view in order to recreate the sensation of depth associated with the separation of the eyes. There exist various autostereoscopic methods. By way of example, the autostereoscopic screen technology known under the brand “Alioscopy” and marketed by the company of the same name allows the use of the method according to the invention. If two different images are displayed instead of two points of view, the user sees a different image depending on the position of his head with an intermediate position where the two images are visible to both eyes as illustrated in FIG. 2 which shows the binocular image seen by the user. It is recalled that this image in FIG. 2 is not generated as such by the system. It corresponds to the reconstitution that the brain of the user makes of it based on images seen by his left and right eyes in the same manner as, with two stereoscopic images, an observer reconstitutes the sensation of relief. In this FIG. 2, the two images IG and ID are combined and superposed and form the final image IG+ID.

By way of a second example, the display system S used can be a stereoscopic system with elements mounted on the head of the user such as a pair of polarized glasses or any other system for stereoscopic or 3D vision.

By way of a third example illustrated in FIG. 3, the display system S used can be a binocular system comprising two display devices SG and SD mounted on the head of the user. Each display device provides a collimated image in front of each eye.

In these two latter cases, the user constantly sees the two superposed images.

1. Method for displaying at least two images intended to be superposed so as to form only one final image, wherein the method comprises the two following successive steps:
A first step for generation of the first image and of the second image, the two images being of a different nature and non-stereoscopic;
A second step for displaying the said images in a binocular or stereoscopic display system comprising two display channels, the first channel being intended for the right eye of a user, the second channel being intended for the left eye of the said user, the first image being displayed on the first right channel and the second image being displayed on the second left channel.

2. Display method according to claim 1, wherein the binocular display system is a helmet display.

3. Display method according to claim 1, wherein the stereoscopic display system comprises a single display screen.

4. Display method according to claim 1, wherein the first image or the second image comprises information of the planimetric type.

5. Display method according to claim 1, wherein the first image or the second image comprises information of the cartographic type.

6. Display method according to claim 1, wherein the first image or the second image comprises information relating to the piloting or the navigation of an aircraft.
